(19) United States
(12) Patent Application Publication
(10) Pub. No.: US 2015/0198238 A1
(43) Pub. Date: Jul. 16, 2015

(54) SHIFTER ASSEMBLY

(71) Applicant: LEGEND GEAR & TRANSMISSION, INC., Statesville, NC (US)

(72) Inventors: Kevin Smith, Olin, NC (US); Mike Spann, Hamptonville, NC (US)

(73) Assignee: LEGEND GEAR & TRANSMISSION, INC., Statesville, NC (US)

(21) Appl. No.: 14/153,761

(22) Filed: Jan. 13, 2014

(51) Int. Cl. F16H 59/04

(52) U.S. Cl. CPC F16H 59/04

(57) ABSTRACT

A vehicle shifter for use with a transmission is provided that is mountable on a transmission and can operate the transmission via an operating member held by a housing. The operating member may engage the transmission with a first end, and may be actuated by a user via a shift knob adapter at a second end. The operating member may be limited in its movement by a pin member, which is configured to engage the housing. The pin member may be urged towards a neutral position by opposingly positioned bias members. In some cases, the shift knob adapter may be offset from the second end of the operating member by a connector plate, and may be adjustable via splined connections. The splines may cooperate with the connector plate to allow the shift knob adapter to be maintained in a chosen rotational orientation.

### TECHNICAL FIELD

This invention relates generally to shifters for automotive transmissions or the like.

### BACKGROUND

Automotive shifters generally allow the user of an automobile to change gears in a manual transmission. The shifters operate by translating the user's input to actuate the various components in the transmission and engage the desired gear. It may be helpful for a shifter to be responsive and easy to shift so as to improve the overall performance of the vehicle.

### SUMMARY

Automotive shifters may be attached to the top of a transmission to allow the user to change gears from inside the vehicle. The performance of a vehicle is limited by the speed and efficiency with which the user can change gears. High-performance vehicles may be impaired by a slow or difficult-to-use shifter. Having a shifter that helps the user smoothly change between gears can greatly improve the performance of the vehicle, but the way a shifter is configured, both internally and externally, has a substantial impact on its feel and performance. Moreover, each user and each vehicle may have different needs that make it difficult for a single shifter to always perform well in different situations. Accordingly, embodiments of the invention described herein relate to a responsive, high-performance shifter that may be adjusted to a specific user or vehicle's needs.

In some embodiments, a shifter is provided that may be mountable on a manual transmission. The shifter may comprise a housing configured to be mounted on a transmission. The housing may define a cavity. The shifter may have an operating member comprising a first end configured to engage with the transmission, a second end configured to be actuated by a user, and an intermediate portion disposed between the first and second ends and configured to be received within the cavity of the housing. The shifter may also have a pin member extending outwardly from opposite sides of the intermediate portion of the operating member. At least a portion of the pin member may be configured to engage the housing so as to limit movement of the operating member between a first position and a second position and may allow rotation of the intermediate portion within the cavity of the housing about a longitudinal axis of the pin member. The shifter may also have a plurality of independent bias members mounted within the housing, which may be configured to opposingly engage the pin member on opposite sides of the intermediate portion such that the operating member may be urged towards a neutral position between the first and second positions.

In some embodiments, the housing may define two slots that are disposed on opposite sides of the housing with respect to the operating member and may be configured to engage opposite ends of the pin member.

In some embodiments, the shifter may include a shift knob adapter configured to attach to the second end of the operating member. The shifter may also have a connector plate defining a first hole and a second hole. The first hole may be configured to receive the second end of the operating member and the second hole may be configured to receive an end of the shift knob adapter so as to allow the user to actuate the operating member via the shift knob adapter.

Additionally, in some embodiments, the second end of the operating member may define splines, and the first hole of the connector plate may comprise corresponding splines such that the operating member and the connector plate may be configured to selectively engage each other at various rotational positions about a central axis of the first hole. Additionally or alternatively, the end of the shift knob adapter may define splines, and the second hole of the connector plate may comprise corresponding splines such that the shift knob adapter and the connector plate may be configured to selectively engage each other at various rotational positions about a central axis of the second hole.

In some embodiments, the shifter may comprise a plurality of bushings disposed within the cavity of the housing at least partially surrounding the intermediate portion of the operating member. The bushings may be spaced apart from each other at a distance corresponding to a width of the slots so as to allow the pin member to extend and move therebetween.

In some embodiments, the housing may be comprised of a base plate and a main portion. The main portion of the housing may define a shape that corresponds to a shape of the intermediate portion of the operating member.

In some embodiments, the operating member may define a first axis extending between the first end and the second end of the operating member. The longitudinal axis of the pin member may be substantially perpendicular to the first axis.

The plurality of bias members, in some embodiments, may comprise two pairs of bias members. Each pair of bias members may be disposed proximate an end of the pin member, with each bias member of a respective pair of bias members arranged coaxially with respect to the other bias member of the respective pair and may be configured to act in an opposing direction with respect to the other bias member of the respective pair.

In another example embodiment, a method may be defined for assembling a shifter mountable on a manual transmission. The method may comprise providing a housing configured to be mounted on a transmission, and the housing may define a cavity. The method may further comprise disposing an intermediate portion of an operating member within the cavity of the housing. The intermediate portion may extend between a first end configured to engage with the transmission and a second end configured to be actuated by a user. The method may also comprise extending a pin member outwardly from opposite sides of the intermediate portion. At least a portion of the pin member may be configured to engage the housing so as to limit movement of the operating member between a first position and a second position and may allow rotation of the intermediate portion within the cavity of the housing about a longitudinal axis of the pin member. The method may further include mounting a plurality of independent bias members within the housing such that the bias members may opposingly engage the pin member on opposite sides of the intermediate portion and may urge the operating member towards a neutral position between the first and second positions.

In some embodiments, the method may include defining two slots in the housing that are disposed on opposite sides of the housing with respect to the operating member and may be configured to engage opposite ends of the pin member.

Some embodiments of the method include attaching a shift knob adapter to the second end of the operating member. The method may include attaching a connector plate defining a first hole and a second hole. The method may further include disposing the second end of the operating member within the first hole of the connector plate, and disposing an end of the shift knob within the second hole of the connector plate so as to allow the user to actuate the operating member via the shift knob adapter.

Additionally, in some embodiments, the second end of the operating member may define splines and the first hole of the connector plate may comprise corresponding splines. The method may further comprise selectively engaging the operating member and the connector plate at a chosen rotational position about a central axis of the first hole. Additionally or alternatively, the end of the shift knob adapter may define splines, and the second hole of the connector plate may comprise corresponding splines. The method may further comprise selectively engaging the shift knob adapter and the connector plate at a chosen rotational position about a central axis of the second hole.

In some embodiments, the method may further comprise disposing a plurality of bushings within the cavity of the housing and at least partially surrounding the intermediate portion of the operating member. The bushings may be spaced apart from each other at a distance corresponding to a width of the slots so as to allow the pin member to move therebetween.

In some additional embodiments, the housing may be comprised of a base plate and a main portion. The main portion of the housing may define a shape that corresponds to a shape of the intermediate portion of the operating member.

Additionally, in some embodiments, the operating member may define a first axis extending between the first end and the second end of the operating member. The longitudinal axis of the pin member may be substantially perpendicular to the first axis.

In some embodiments, the plurality of bias members may comprise two pairs of bias members. Each pair of bias members may be disposed proximate an end of the pin member. Each bias member of a respective pair of bias members may be arranged coaxially with respect to the other bias member of the respective pair and may be configured to act in an opposing direction with respect to the other bias member of the respective pair.

### BRIEF DESCRIPTION OF THE SEVERAL VIEWS OF THE DRAWINGS

FIG. 1 shows a perspective view of a shifter mounted to a transmission in accordance with an example embodiment of the present invention described herein;

FIG. 2 shows a perspective view of a shifter in accordance with an example embodiment of the present invention described herein;

FIG. 3 shows an exploded perspective view of the shifter shown in FIG. 2 in accordance with an example embodiment of the present invention described herein;

FIG. 4 shows a side view of the shifter shown in FIG. 2 having a portion of the housing removed in accordance with an example embodiment of the present invention described herein;

FIG. 5 shows a side view of the shifter shown in FIG. 2 in accordance with an example embodiment of the present invention described herein;

FIG. 6 shows a side view of a shifter with the operating member in a first position in accordance with an example embodiment of the present invention described herein;

FIG. 7 shows a side view of a shifter with the operating member in a second position in accordance with an example embodiment of the present invention described herein;

FIG. 8 shows a side view of the shifter shown in FIG. 6 with the operating member in the first position and having a portion of the housing removed in accordance with an example embodiment of the present invention described herein;

FIG. 9 shows a side view of the shifter shown in FIG. 7 with the operating member in the second position and having a portion of the housing removed in accordance with an example embodiment of the present invention described herein;

FIG. 10 shows an operating member and a pin member in a neutral position defining a first axis and a longitudinal axis in accordance with an example embodiment of the present invention described herein;

FIG. 11 shows the operating member and pin member of FIG. 10 deflected from the neutral position in accordance with an example embodiment of the present invention described herein;

FIG. 12 shows an exploded perspective view of a shift knob adapter, connector plate, and operating member in accordance with an example embodiment of the present invention described herein;

FIG. 13 shows a perspective view of the shift knob adapter, connector plate, and operating member of FIG. 12 assembled in accordance with an example embodiment of the present invention described herein;

FIG. 14 shows a top view of the shift knob adapter of FIG. 13 in accordance with an example embodiment of the present invention described herein; and

FIG. 15 shows a top view of a shift knob in a simplified configuration with an operating member in accordance with an example embodiment of the present invention described herein.

### DETAILED DESCRIPTION OF THE INVENTION

Embodiments of the present invention will now be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. The term “or” is used herein in both the alternative and conjunctive sense, unless otherwise indicated. The terms “illustrative” and “exemplary” are used to be examples with no indication of quality level. The terms “first” and “second” are used for reference purposes only and are not limiting. Like numbers refer to like elements throughout.

Automotive shifters are used to actuate a manual transmission. Transmissions contain gears, which are used to selectively control the ratio of input at an engine to output at a vehicle's wheels. This means that for a given input speed from the engine, typically described in revolutions per minute (RPM), the transmission can produce different output speeds of the vehicle depending on which gear is chosen. Typically, a user will engage the gears sequentially in ascending or decending order of gear ratio to cause a vehicle to accelerate or decelerate, respectively. In order to control and selectively engage the gears, a shifter is typically provided between a user and the transmission. Shifters are used in a wide range of vehicles including large trucks, sports cars, sedans, motorcycles, and the like. Automotive shifters normally comprise a shift lever mounted to a housing such that the shift lever may pivot within the housing. One end of the shifter may be gripped and manipulated by the user, while the opposing end engages the transmission.

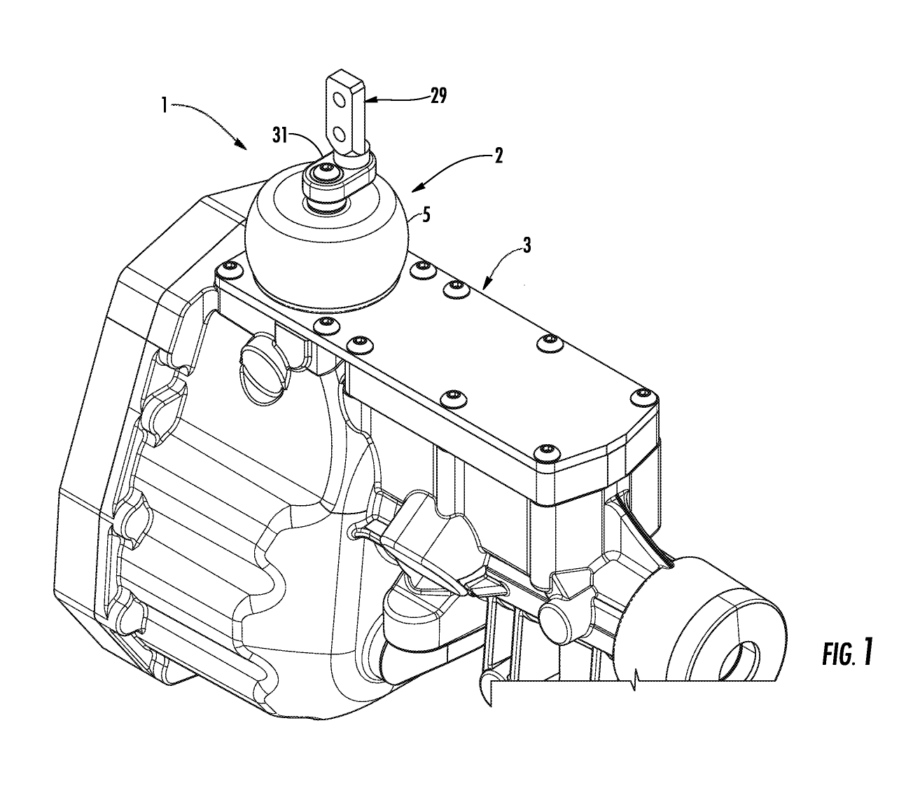

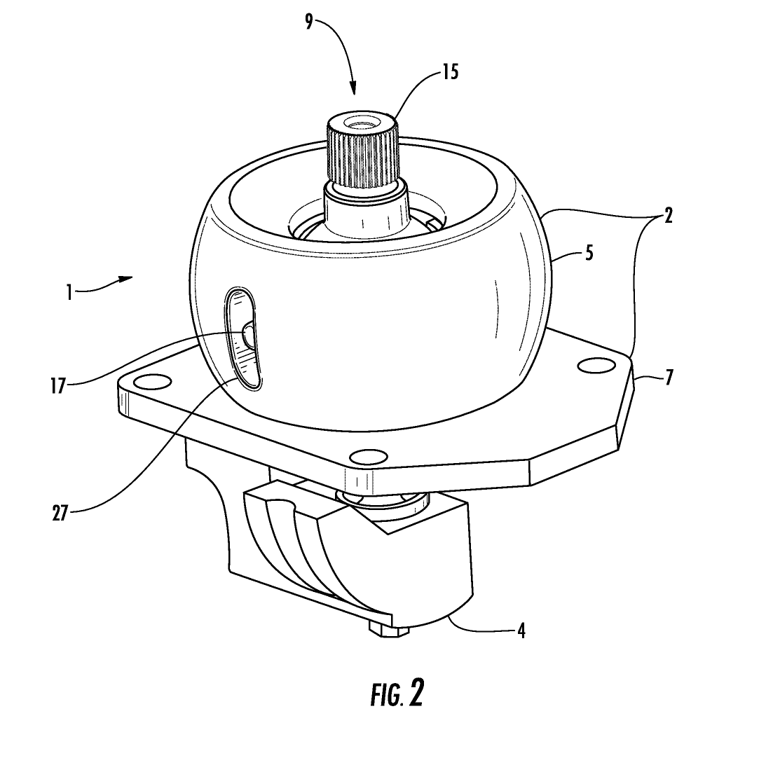

An automotive shifter 1 according to embodiments of the present invention is illustrated in FIG. 1. The shifter 1 may be configured to be installed on a transmission 3, such that the shifter 1 enables the vehicle's driver to control the transmission 3. With reference to FIG. 2, the shifter 1 may have an operating member 9 surrounded by a housing 2, where the housing 2 is mountable on a transmission 3 (shown in FIG. 1). The operating member 9 is configured to actuate a portion 4 of the transmission 3 in response to input from the user. The housing 2 may be either partially or entirely hollow such that it defines a cavity for receiving the operating member 9. The shifter may be made of any suitable material, such as aluminum or steel.

The housing 2 may take any of a number of shapes and configurations. With reference to FIG. 4, one such embodiment of the housing 2 defines a main portion 5 of the housing 2 and a base plate 7, wherein the main portion 5 defines a shape that corresponds to a shape of the intermediate portion 13 of the operating member 9. The main portion 5 may then be attached to the base plate 7, where the base plate 7 is configured to be attached to the transmission 3. The base plate may be complementary to the shape of the transmission 3, so as to enable the shifter 1 to engage with the transmission 3. FIG. 1 depicts one embodiment of the housing 2 attached to the transmission 3.

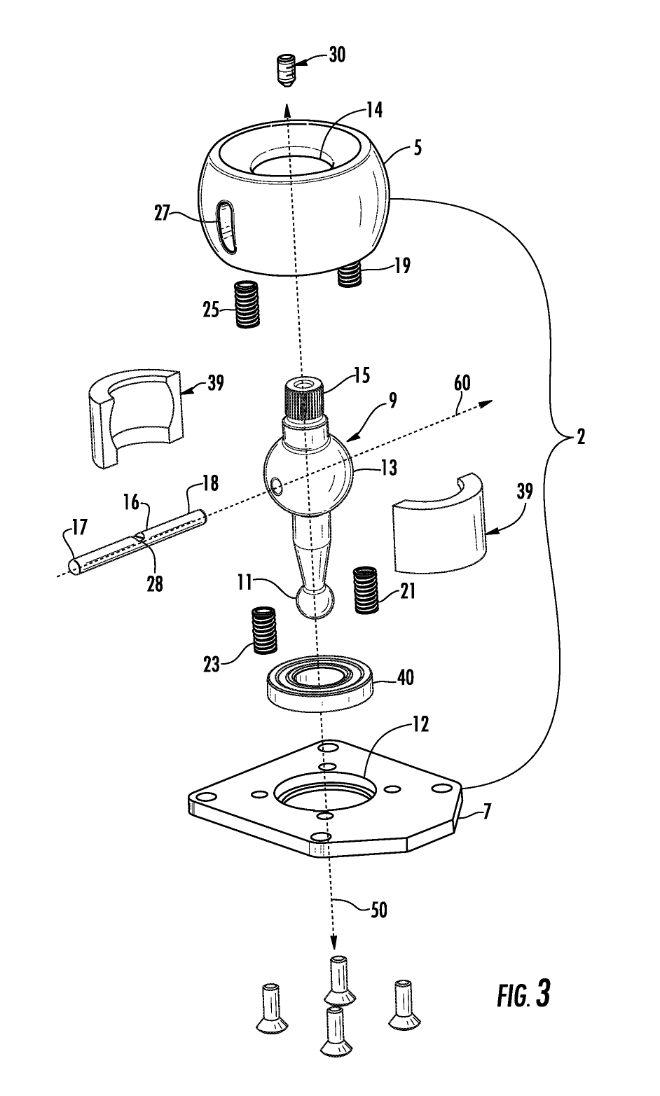

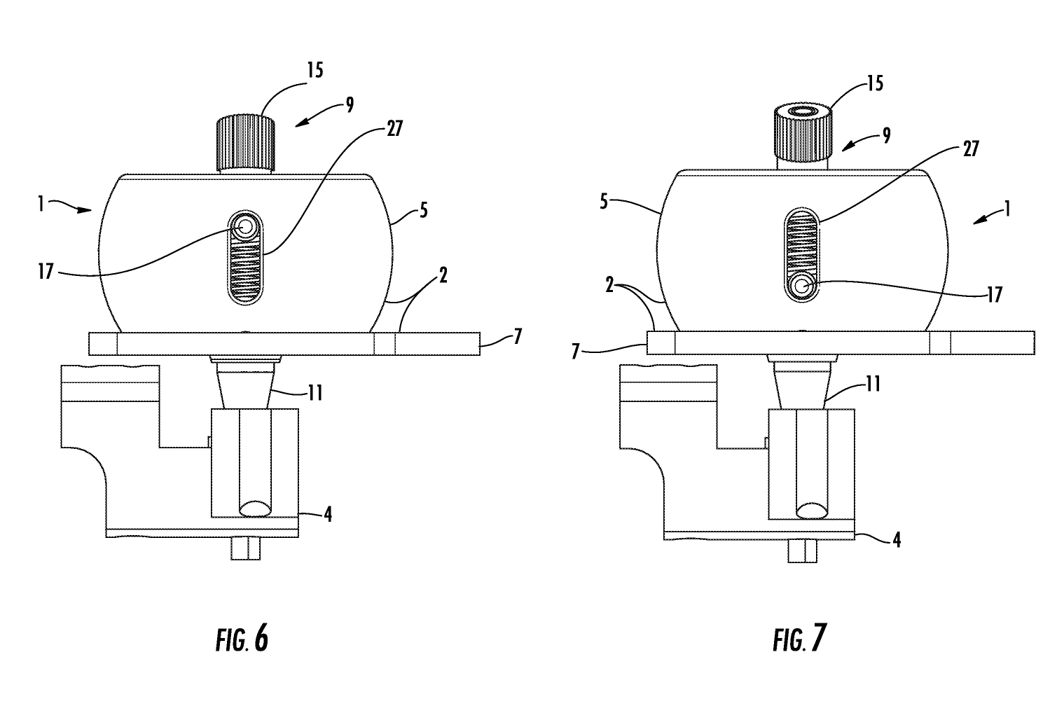

With reference to FIGS. 3-4, in some embodiments, the operating member 9 may be a lever-shaped device that is configured to actuate a portion 4 of the transmission 3 via a first end 11 and may be actuated by a user, either directly or indirectly, via a second end 15. An intermediate portion 13 may be positioned along a first axis 50 that is defined by the first end 11 and the second end 15 of the operating member 9. In some embodiments, the intermediate portion 13 is configured to be received within the cavity of the housing 2. The intermediate portion 13 may be pivotally mounted in the housing 2 such that the operating member 9 may rotate within the housing 2, as shown in FIGS. 6-9 and described below.

In order to facilitate the rotation of the operating member 9, the intermediate portion 13 may be at least partially spherical in shape in some embodiments. In an exemplary embodiment, the second end 15 projects out of one end of the housing 2, and the first end 11 projects out the other end of the housing 2. For example, with respect to the installed position on top of the transmission 3, as shown in FIG. 1, the second end 15 (shown in FIG. 2) may project substantially upward, and the first end 11 may project substantially downward (shown in FIG. 4).

The user may interact with the shifter 1 by actuating the operating member 9 via the second end 15. The operating member 9 may pivot within the housing 2 in response to the user's actuation to cause the first end 11 of the operating member to actuate the portion 4 of the transmission 3. By actuating the portion 4 of the transmission 3 via the operating member 9, the user may control the transmission 3 and use the shifter 1 to select and engage his or her desired gear.

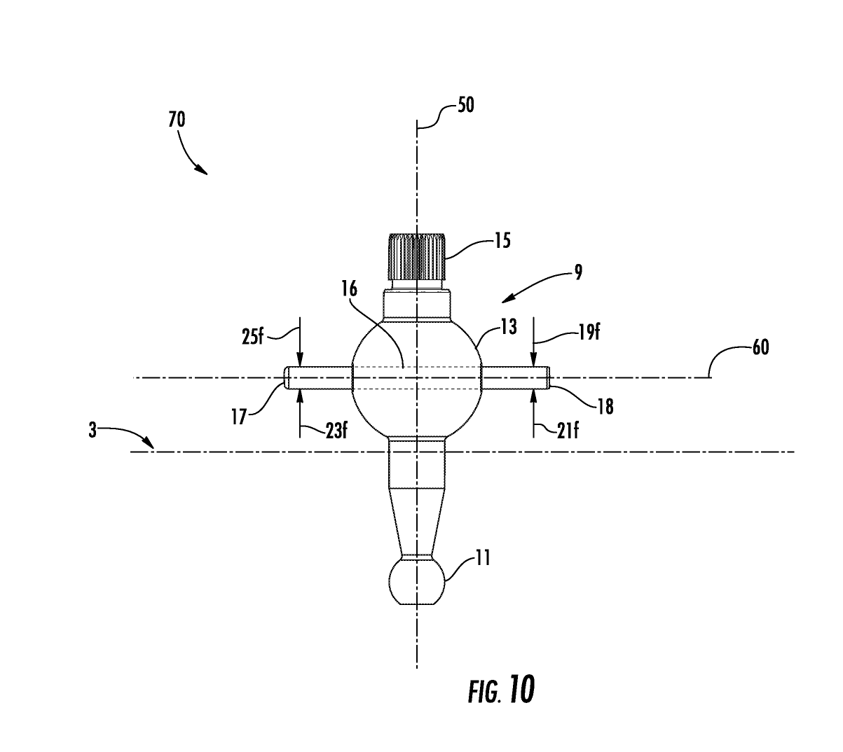

In some embodiments, a pin member 16 may be provided that extends outwardly from opposite sides of the intermediate portion 13. At least a portion of the pin member 16 may be configured to engage the housing 2. In some embodiments, the pin member 16 may be a solid rod that is fit through a hole in the intermediate portion 13 of the operating member 9. The pin member 16 may be affixed to the intermediate portion 13 with a set screw 30, press fit, or the like. For example, FIG. 3 depicts a pin member 16 with a notch 28 proximate the center. The notch 28 may receive a set screw 30 inserted through the second end 15 of the operating member 9 to engage the pin member 16 and hold it within the intermediate portion 13 of the operating member 9. In some embodiments, the pin member 16 may be substantially cylindrical in shape. The pin member 16 may define a longitudinal axis 60 (shown in FIG. 10) that runs longitudinally from a first end 17 to a second end 18 of the pin member 16 through the intermediate portion 13 of the operating member 9 and may intersect with the first axis 50 of the operating member 9 near the center of the intermediate portion 13. The first axis 50 and the longitudinal 60 axis may define a plane of the shifter 1. In some embodiments, the longitudinal axis 60 of the pin member 16 may be perpendicular to the first axis 50 of the operating member 9, as shown in FIGS. 3-4, 10-11.

In some cases, the housing 2 may define slots 27 disposed on opposite sides of the housing 2, such that the ends 17, 18 of the pin member 16 may engage the slots 27 to limit the motion of the operating member 9. The slots 27 may be channels formed by protrusions extending into the cavity of the housing 2 from opposite walls of the housing 2 with respect to the operating member 9. The slots 27 may be cut entirely through the housing 2 to form an opening, such that the outer surface of the housing 2 is broken, as shown in FIG. 2. Alternatively, the slots may stop partially through the housing 2, such that the outer surface of the housing 2 is smooth. In some embodiments, the slots 27 may be oriented so as to be aligned with the plane of the shifter 1 formed by the first axis 50 and the longitudinal 60 axis (shown in FIG. 10). The pin member 16 may be cylindrical in shape so as to allow rotation of the ends 17,18 of the pin member 16 about the longitudinal axis 60 within the slots 27.

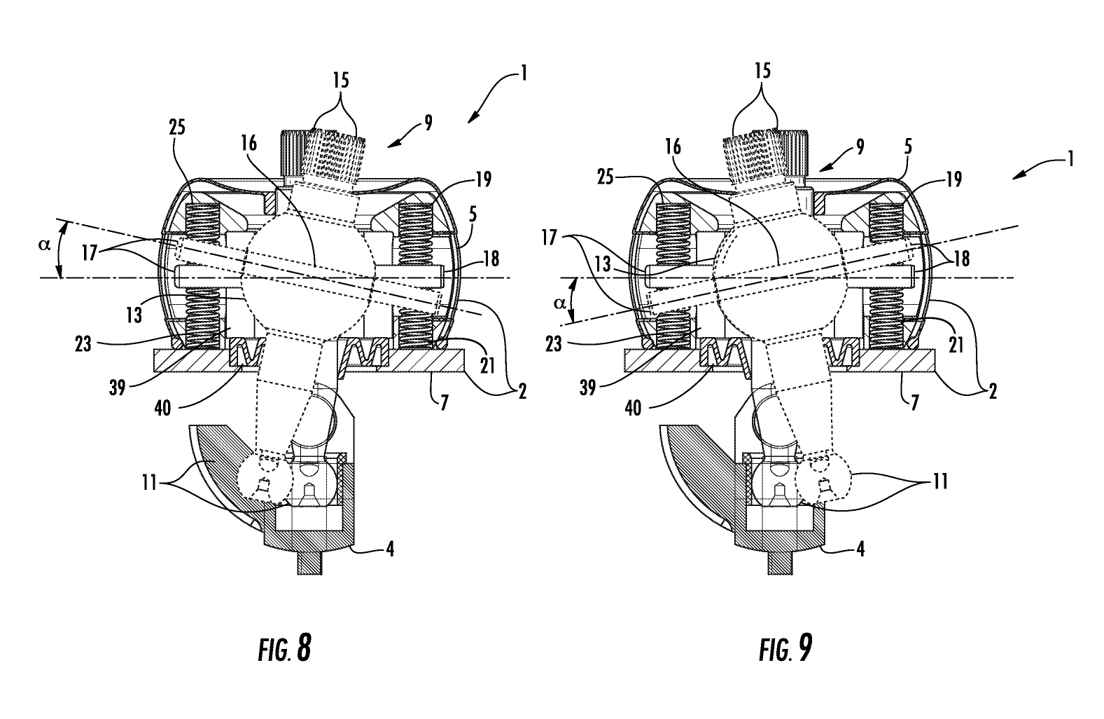

In some embodiments, the movement of the operating member 9 may be limited by the pin member 16 between a first position (shown in FIGS. 6 and 8) and a second position (shown in FIGS. 7 and 9) and may comprise rotation about the longitudinal axis 60 of the pin member 16. In an exemplary embodiment, the first position and second position of the operating member 9 represent the farthest possible displacements (e.g., defining an angle α between a neutral position 70 and the first or second positions) of the ends 17, 18 of the pin member 16 within the housing 2 in the plane of the shifter. In an exemplary embodiment, the intermediate portion 13 of the operating member 9 may be pivotally held within the housing 2, so that as one end 17 of the pin member 16 reaches one end of its corresponding slot 27, the other end 18 of the pin member 16 reaches the opposite end of its corresponding slot 27. The first position is shown in FIGS. 6 and 8, while the second position is shown in FIGS. 7 and 9.

In some embodiments, the first and second positions may not necessarily be determined by the slots 27. The movement of the operating member 9 may be restricted by any of the structures within or outside the shifter 1. For example, as shown in FIG. 3, the housing 2 may limit the motion of the operating member 9 as a result of the configuration of an upper hole 14 in the housing 2 that contacts the operating member 9 when the operating member 9 is displaced by an angle α to achieve the first and second positions. Likewise, a lower hole 12 in the housing 2 may limit the motion of the operating member 9 when the operating member 9 is displaced at an angle α in the first and second positions. Additionally or alternatively, the transmission 3 and/or the gears may limit the range of motion of the shifter 1 to the range required for actuation of the various components of the transmission 3. For example, the transmission 3 may limit the motion of the operating member 9 to movement between the first and second positions in the plane of the shifter 1 and a rotation about the longitudinal axis 60 of the pin member 16. In some embodiments, a plurality of bias members 19, 21, 23, 25, described in detail below, may limit the motion of the operating member 9 when the bias members 19, 21, 23, 25 are at their maximum deflection and the operating member 9 is displaced at an angle α in the first and second positions. Any single structure or plurality of structures within or outside the shifter 1 and/or transmission 3 may limit the motion of the operating member 9.

As described above, the operating member 9 may be held within a cavity of the housing. The housing 2 may have any of a number of support structures configured to receive the operating member 9 based on the external shape of the operating member 9 and to confine the operating member 9 to a desired range of motion. In some embodiments, the housing 2 may receive the intermediate portion 13 of the operating member 9 and allow the first 11 and second 15 ends of the operating member 9 to protrude from the housing 2. For example, as depicted in FIGS. 3-4, one or more bushings 39 may be provided that are disposed within the cavity of the housing 2. The bushings 39 may, at least partially, surround the intermediate portion 13 of the operating member 9 in order to pivotally support the operating member 9. In some embodiments, there may be two bushings 39 arranged on either side of the pin member 16. In some further embodiments, the bushings 39 may be spaced apart from each other at a distance approximately corresponding to the width of the slots 27 and the width of the pin member 16 so as to allow the pin member 16 to extend and move therebetween.

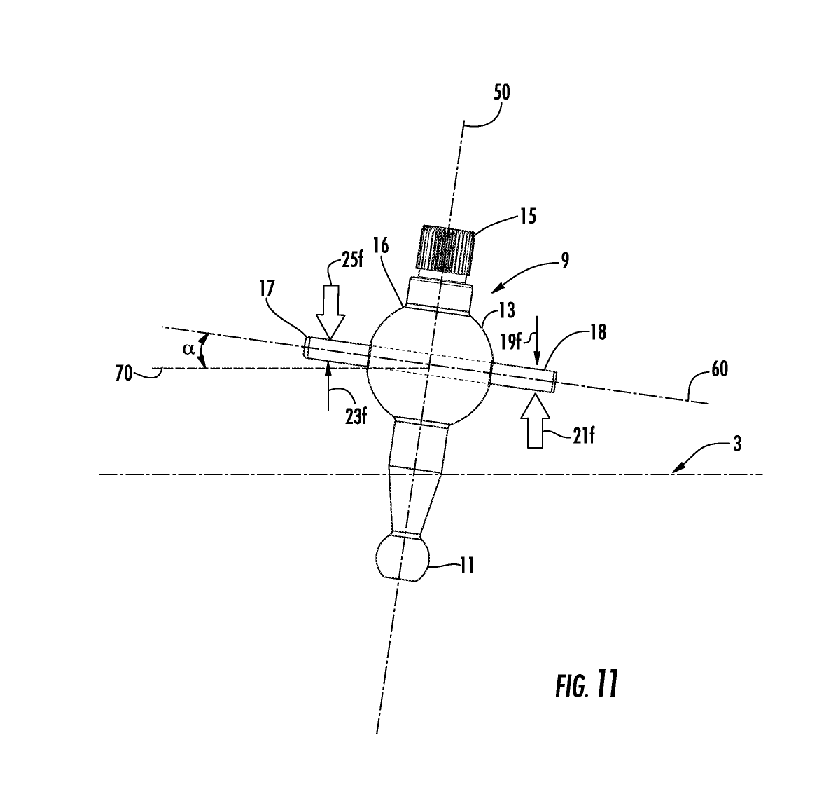

In some embodiments, as depicted in FIGS. 4-11, the pin member 16, and by extension the operating member 9, may be urged towards a neutral position 70 by a plurality of bias members 19, 21, 23, 25. The bias members 19, 21, 23, 25 may be any resistive mechanism. For example, the embodiment shown in FIG. 4, the bias members 19, 21, 23, 25 are coil springs. Other types of springs and mechanisms are also envisioned. The bias members 19, 21, 23, 25 may be configured to engage the pin member 16 in pairs with each pair being arranged on an opposite side of the operating member 9. In some embodiments, two pairs of bias members 19, 21, 23, 25 may be arranged such that the two bias members of each pair are coaxial and configured to act in an opposing direction with respect to each other. In some exemplary embodiments, the bias members 19, 21, 23, 25 may be disposed proximate the ends 17, 18 of the pin member 16. For example, in FIG. 4, one pair of bias members is comprised of spring 19 and spring 21, and a second pair of bias members is comprised of springs 23 and 25. In FIG. 4, the springs 19, 21 of one pair are coaxial and are disposed proximate the second end 18 of the pin member 16. The springs 19, 21 apply opposing forces 19f, 21f against one another and on opposite sides of the pin member 16 to maintain the pin member 16 in the neutral position 70 as shown in FIGS. 10-11. Likewise, the springs 23, 25 of the other pair are coaxial, are disposed proximate the first end 17 of the pin member 16, and apply forces 23f, 25f against each other on opposite sides of the pin member 16.

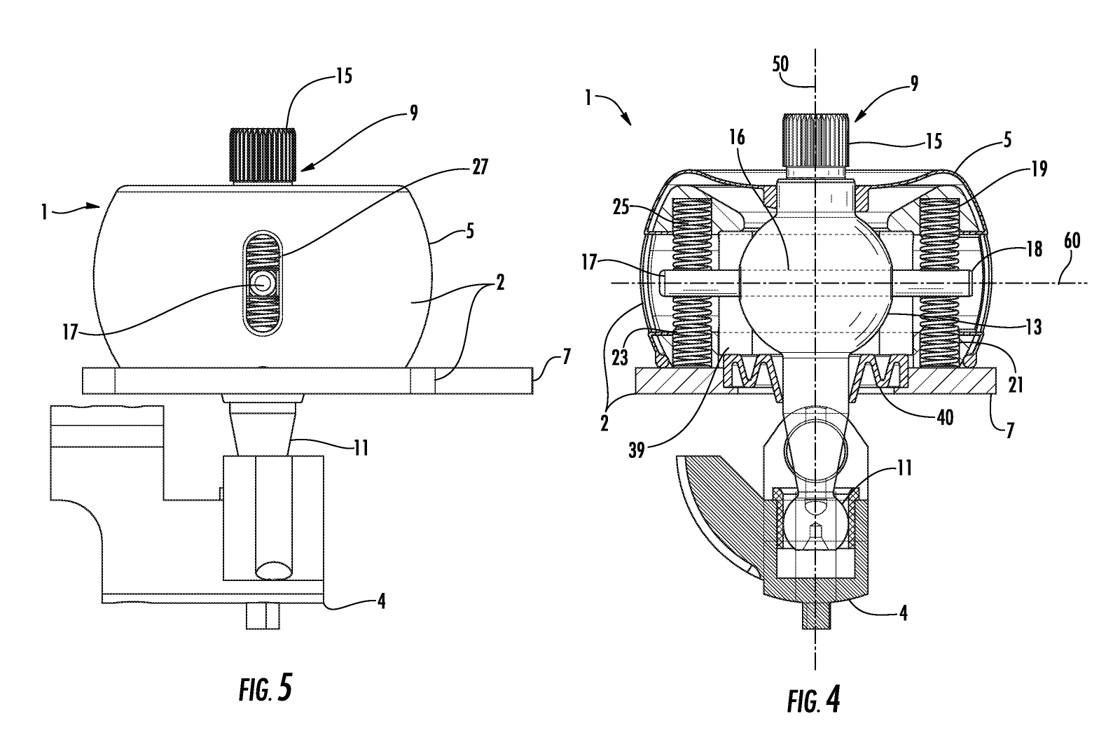

In some embodiments, the neutral position 70 (shown in FIGS. 10-11) is an intermediate, resting position of the shifter 1. The neutral position 70 may be defined as a location between the first and second positions that is appropriate for the actuation of the transmission 3. In one embodiment, the neutral position 70 lies along the direction of travel of the pin member 16 within the slots 27, as shown in FIGS. 5-7. The neutral position 70 may lie within the plane of the shifter 1, as shown in FIGS. 10-11. In some embodiments the neutral position 70 may be directly in between the first and second positions such that the pin member 16 rests horizontally with respect to the transmission 3 as shown in FIGS. 5, 10.

In addition to the position described above, the neutral position 70 may be defined rotationally about the longitudinal axis 60 of the pin member 16 such that the operating member 9 is also substantially vertical about the longitudinal axis 60 with respect to the transmission 3 while the pin member 16 and operating member 9 are in the neutral position 70 within the plane of the shifter 1 (e.g., shown in FIG. 10). The exact location of the neutral position 70 may depend on the internal structure of the transmission 3. A person of ordinary skill in the art will appreciate that the neutral position 70 may be within a reasonable tolerance from the horizontal axis of the pin member 16 with respect to the top of the transmission 3 to accommodate positioning of the shifter or the various components of the transmission 3.

The bias members 19, 21, 23, 25 may operate by applying a restorative force to the pin member 16 so that whenever the pin member 16 is displaced from the neutral position 70 within the slots 27, the bias members urge the pin member back to the neutral position. For example, FIG. 10 depicts the forces 19f, 21f, 23f, 25f applied by the respective bias members 19, 21, 23, 25 on the pin member 16 in the neutral position. In the neutral position 70, the forces 19f, 21f, 23f, 25f are balanced. FIG. 11 shows an increase in force 21f, 25f, represented by larger arrows, applied by the bias members 21 and 25 and a decrease in the forces 19f, 23f, represented by smaller arrows, applied by the bias members 19 and 23 in response to a deflection of the pin member 16 (e.g., via actuation of the operating member 9) by an angle α towards the first position (e.g., shown in FIGS. 6, 8). In some embodiments, the bias members 19, 21, 23, 25 may be configured to always resist the movement of the operating member 9, even in the neutral position 70, and the magnitude of the forces varies by the angle α of the deflection of the operating member. Alternatively, the bias members 19, 21, 23, 25 may not apply force to the operating member 9 while in the neutral position 70. In the embodiment shown in FIGS. 4, 8-9, the bias members 19, 21, 23, 25 may be disposed on opposite sides of the operating member 9 so that the linear resistance of the bias members causes a rotational motion in the operating member 9 within the plane of the shifter 1. As discussed in greater detail below, the bias members may be disposed proximate the respective ends 17, 18 of the pin member 16.

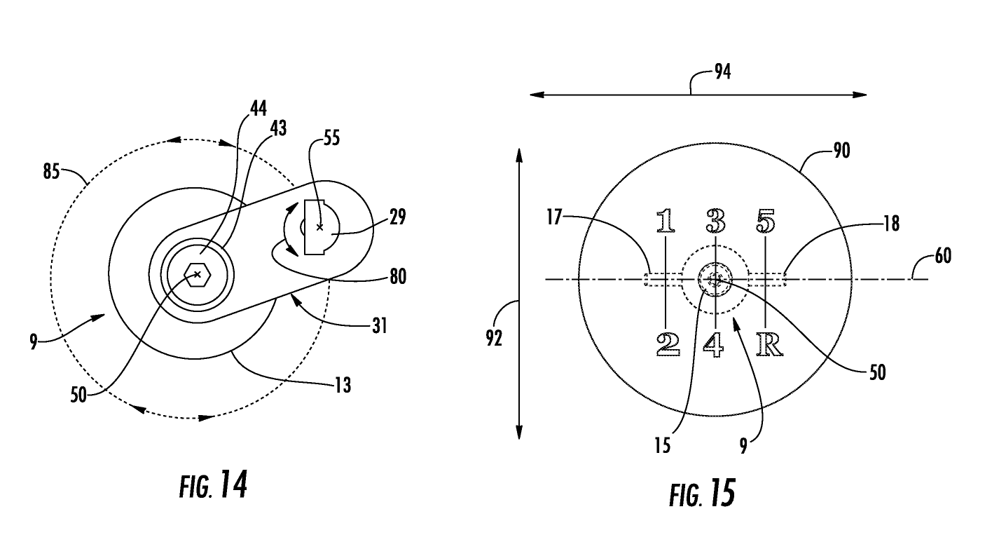

The bias members 19, 21, 23, 25 may attempt to return the operating member 9 to the neutral position 70 within the plane in response to deflection of the operating member 9 by a user as shown in FIGS. 10-11. In one embodiment, the bias members 19, 21, 23, 25 act in the plane of the shifter 1, but the bias members 19, 21, 23, 25 may operate in whichever direction is necessary for proper actuation of the shifter 1. In some embodiments, the bias members 19, 21, 23, 25 may not resist the rotation of the operating member 9 about the longitudinal axis 60 of the pin member 16 (e.g., the direction of arrow 92 in FIG. 15) and may only apply resistance within the plane of the shifter 1 (e.g., the direction of arrow 94 in FIG. 15). For example, in some embodiments, the operating member 9 may be rotatable about the longitudinal axis 60 within the slots 27 (shown as arrow 92 in FIG. 15). Accordingly, the operating member 50 may not rotate about the first axis 50 because of resistance from the slots 27, and is resisted in its rotation within the plane of the shifter 1 because of the bias members 19, 21, 23, 25 (shown as arrow 94 in FIG. 15). In some exemplary embodiments and as shown in FIG. 15, the gears of the shifter may be arranged such that movement of the shift knob 90, and as a result the operating member 9, about the longitudinal axis 60 (e.g., the direction of arrow 92 in FIG. 15) engages a selected gear and movement of the shift knob 90 within the plane of the shifter (e.g., the direction of arrow 94 in FIG. 15) aligns the operating member 9 with the desired gear. Accordingly, the components of the shifter 1 may apply little or no resistance to the operating member 9 about the longitudinal axis 60 so that the shifter 1 is not pulled out of gear, but may provide resistance within the plane of the shifter 1 to urge the shifter 1 back to a neutral position 70 once a gear is disengaged.

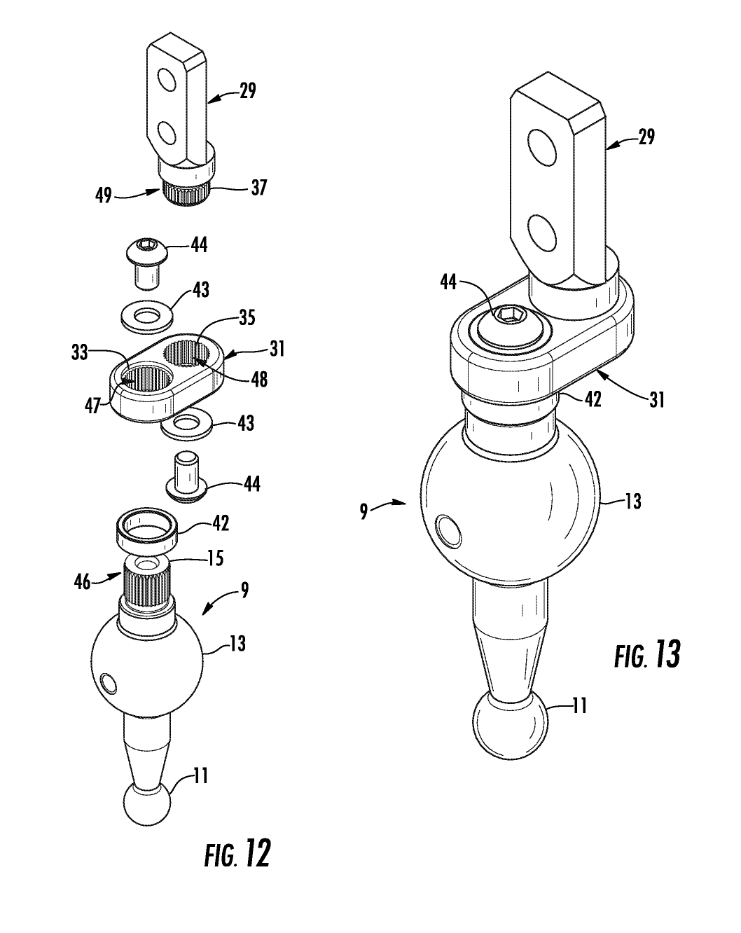

In some embodiments and as is shown in FIGS. 12-13, the second end 15 of the operating member 9, which is configured to be actuated by the user, further comprises a shift knob adapter 29 for attaching a user operable shift knob 90 (shown in FIG. 15). The shift knob 90 may be a handle, lever, or the like, which allows the user to grasp and manipulate the operating member 9 and, thereby, actuate the transmission 3. The shift knob adapter 29 may be directly attached to the second end 15 of the operating member 9 and may be coaxial with the first axis 50 of the operating member 9, or it may be offset from the first axis 50 of the operating member 9 via a connector plate 31, as in a depicted embodiment. In an exemplary embodiment shown in FIGS. 12-13, the connector plate 31 may have a first hole 33 and a second hole 35. The first hole 33 may be configured to receive the second end 15 of the operating member 9, and the second hole 35 may be configured to receive an end 37 of the shift knob adapter 29. The axis of the shift knob adapter 29 and the first axis 50 of the operating member 9 may be substantially parallel as shown in FIG. 13.

The effect of the connector plate 31 may be to offset the shift knob adapter 29 from the first axis 50 of the operating member 9 and to adjust the orientation of the shift knob adapter with respect to the operating member. As shown in FIG. 14, the shift knob adapter 29 may be rotatably adjusted about a central axis 55 of the second hole 35, as represented by arrow 80, and may be rotatably adjusted about a first arc 85 with respect to a central axis 50 of the first hole 33. For example, FIG. 14 shows the rotation of the shift knob adapter 29 about the second arc 80, and the rotation of the shift knob adapter 29 via the connector plate 31 about the first arc 85. Offsetting the shift knob adapter 29 may give the user more control over the feel of the shifter 1 and may allow greater adjustability of the shifter 1 to satisfy the user's comfort and performance preferences.

In some embodiments, the length of the shift knob 90, shift knob adapter 29, operating member 9, and/or connector plate 31 (collectively, the shifter assembly) may be varied to alter the performance of the shifter. For example, a shorter shifter assembly generally requires more force to actuate but moves quicker between the gears. Alternatively, a longer shifter assembly may be easier to actuate but may have a slower response time due to the increased distance the user must move through to engage each gear. The user may balance the respective speed and ease of use considerations to determine an optimal shifter configuration that provides the desired performance for that user.

The connector plate 31 may be attached to the shift knob adapter 29 and the operating member 9 in various ways, including via screws, pins, press fitting, or the like. For example, FIGS. 12-13 show the connector plate 31 being attached to the shift knob adapter 29 and the operating member 9 with screws 44 and using a washer 43 and a spacer 42 to hold the connector plate 31 in place. In some embodiments, either or both of the second end 15 of the operating member 9 and the end 37 of the shift knob adapter 29 may define splines 46, 49. The first 33 and second 35 holes of the connector plate 31 may define corresponding splines 47, 48. In an exemplary embodiment and as shown in FIG. 12, the splines 46, 49 are projections that extend radially outward from the second end 15 of the operating member 9 and the end 37 of the shift knob adapter 29, respectively. The splines 46, 49 may be configured (e.g., size, shape, and quantity) to fit into the corresponding splines 47, 48 within the first 33 and second 35 holes of the connector plate 31, such that upon engagement of the corresponding pairs of splined surfaces, the operating member 9 and the shift knob adapter 29 are maintained in a particular rotational position with respect to the connector plate 31.

By selectively engaging the splined surfaces, the connector plate 31 and second end 15 of the operating member 9 may be held at various rotational positions with respect to the central axis 50 of the first hole 33 around the first arc 85 as shown in FIG. 14. Likewise, the splines may allow the shift knob adapter 29 to be selectively engaged with the connector plate 31 at various rotational positions along the second arc 80 as shown in FIG. 14. There may be any number of splines, with more splines corresponding to more available rotational positions. In some embodiments, for example, between 4 and 30 splines may be provided to allow for sufficient adjustability of the shifter 1.

A method for manufacturing and assembling embodiments of the foregoing invention is also envisioned. In an exemplary embodiment, the method comprises providing a housing 2 configured to be mounted on a transmission 3 as shown in FIG. 1-4, wherein the housing 2 further defines a cavity. The method may further comprise disposing an intermediate portion 13 of an operating member 9 within the cavity of the housing 2, wherein the intermediate portion 13 extends between a first end 11 configured to engage with the transmission 3 and a second end 15 configured to be actuated by a user.

In an exemplary embodiment, the method involves extending a pin member 16 outwardly from opposite sides of the intermediate portion 13, wherein at least a portion of the pin member 16 is configured to engage the housing 2 so as to limit movement of the operating member 9 between a first position and a second position and to allow rotation of the intermediate portion 13 within the cavity of the housing 2 about a longitudinal axis 60 of the pin member 16. In some embodiments, the operating member 9 may define a first axis 50 extending between the first end 11 and the second end 15 of the operating member 9, wherein the longitudinal axis 60 of the pin member 16 is substantially perpendicular to the first axis 50.

Some embodiments further include mounting a plurality of independent bias members 19, 21, 23, 25 within the housing 2 such that the bias members opposingly engage the pin member 16 on opposite sides of the intermediate portion 13 and urge the operating member 9 towards a neutral position 70 between the first and second positions. The plurality of bias members 19, 21, 23, 25 may comprise two pairs of bias members, wherein each pair of bias members is disposed proximate an end 17, 18 of the pin member 16. Each bias member 19, 21, 23, 25 of a respective pair of bias members may be arranged coaxially with respect to the other bias member of the respective pair and may be configured to act in an opposing manner with respect to the other bias member of the respective pair. In some embodiments, the method may further comprise defining two slots 27 in the housing 2 that are disposed on opposite sides of the housing 2 with respect to the operating member and are configured to engage opposite ends 17, 18 of the pin member 16.

In an exemplary embodiment, the method may further comprise attaching a shift knob adapter 29 to the second end 15 of the operating member 9, which is able to receive a shift knob 90 (shown in FIG. 15). The method may also comprise attaching a connector plate 31 defining a first hole 33 and a second hole 35. In some embodiments, the method may comprise disposing the second end 15 of the operating member 9 within the first hole 33 of the connector plate 31 and disposing an end 37 of the shift knob adapter 29 within the second hole 35 of the connector plate 31 so as to allow the user to actuate the operating member 9 via the shift knob adapter 29.

In an exemplary embodiment, the second end 15 of the operating member 9 may define splines 46, and the first hole 33 of the connector plate 31 may comprise corresponding splines 47, such that the operating member 9 and the connector plate 31 may be selectively engaged at a chosen rotational position about a central axis of the first hole 33. Some embodiments of the present invention may define splines 49 at the end 37 of the shift knob adapter 29 and the second hole 35 of the connector plate 31 may comprise corresponding splines 48, such that the shift knob adapter 29 and the connector plate 31 may be selectively engaged at a chosen rotational position about a central axis of the second hole 35.

Some embodiments of the method may involve disposing a plurality of bushings 39 within the cavity of the housing 2 and at least partially surrounding the intermediate portion 13 of the operating member 9 such that the bushings 39 are spaced apart from each other at a distance corresponding to a width of the slots 27 so as to allow the pin member 16 to move therebetween. The housing 2 of an exemplary method may be comprised of a base plate 7 and a main portion 5, wherein the main portion 5 of the housing 2 defines a shape that corresponds to a shape of the intermediate portion 13 of the operating member 9.

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A shifter mountable on a manual transmission, the shifter comprising:
a housing configured to be mounted on a transmission, wherein the housing defines a cavity;
an operating member comprising a first end configured to engage with the transmission, a second end configured to be actuated by a user, and an intermediate portion disposed between the first and second ends and configured to be received within the cavity of the housing;
a pin member extending outwardly from opposite sides of the intermediate portion of the operating member, wherein at least a portion of the pin member is configured to engage the housing so as to limit movement of the operating member between a first position and a second position and allow rotation of the intermediate portion within the cavity of the housing about a longitudinal axis of the pin member; and
a plurality of independent bias members mounted within the housing and configured to opposingly engage the pin member on opposite sides of the intermediate portion such that the operating member is urged towards a neutral position between the first and second positions.

2. The shifter of claim 1, wherein the housing defines two slots that are disposed on opposite sides of the housing with respect to the operating member and are configured to engage opposite ends of the pin member.

3. The shifter of claim 1, further comprising:
a shift knob adapter configured to attach to the second end of the operating member; and
a connector plate defining a first hole and a second hole,
wherein the first hole is configured to receive the second end of the operating member and the second hole is configured to receive an end of the shift knob adapter so as to allow the user to actuate the operating member via the shift knob adapter.

4. The shifter of claim 3, wherein the second end of the operating member defines splines and the first hole of the connector plate comprises corresponding splines such that the operating member and the connector plate are configured to selectively engage each other at various rotational positions about a central axis of the first hole.

5. The shifter of claim 4, wherein the end of the shift knob adapter defines splines and the second hole of the connector plate comprises corresponding splines such that the shift knob adapter and the connector plate are configured to selectively engage each other at various rotational positions about a central axis of the second hole.

6. The shifter of claim 3, wherein the end of the shift knob adapter defines splines and the second hole of the connector plate comprises corresponding splines such that the shift knob adapter and the connector plate are configured to selectively engage each other at various rotational positions about a central axis of the second hole.

7. The shifter of claim 2 further comprising a plurality of bushings disposed within the cavity of the housing and at least partially surrounding the intermediate portion of the operating member,
wherein the bushings are spaced apart from each other at a distance corresponding to a width of the slots so as to allow the pin member to extend and move therebetween.

8. The shifter of claim 1, wherein the housing is comprised of a base plate and a main portion, wherein the main portion of the housing defines a shape that corresponds to a shape of the intermediate portion of the operating member.

9. The shifter of claim 1, wherein the operating member defines a first axis extending between the first end and the second end of the operating member,
wherein the longitudinal axis of the pin member is substantially perpendicular to the first axis.

10. The shifter of claim 9, wherein the plurality of bias members comprises two pairs of bias members,
wherein each pair of bias members is disposed proximate an end of the pin member, with each bias member of a respective pair of bias members arranged coaxially with respect to the other bias member of the respective pair and configured to act in an opposing direction with respect to the other bias member of the respective pair.

11. A method for assembling a shifter mountable on a manual transmission, comprising:
providing a housing configured to be mounted on a transmission, wherein the housing defines a cavity;
disposing an intermediate portion of an operating member within the cavity of the housing,
wherein the intermediate portion extends between a first end configured to engage with the transmission and a second end configured to be actuated by a user;
extending a pin member outwardly from opposite sides of the intermediate portion, wherein at least a portion of the pin member is configured to engage the housing so as to limit movement of the operating member between a first position and a second position and allow rotation of the intermediate portion within the cavity of the housing about a longitudinal axis of the pin member; and
mounting a plurality of independent bias members within the housing such that the bias members opposingly engage the pin member on opposite sides of the intermediate portion and urge the operating member towards a neutral position between the first and second positions.

12. The method of claim 11, further comprising defining two slots in the housing that are disposed on opposite sides of the housing with respect to the operating member and are configured to engage opposite ends of the pin member.

13. The method of claim 11, further comprising:
attaching a shift knob adapter to the second end of the operating member;
attaching a connector plate defining a first hole and a second hole; and
disposing the second end of the operating member within the first hole of the connector plate, and disposing an end of the shift knob within the second hole of the connector plate so as to allow the user to actuate the operating member via the shift knob adapter.

14. The method of claim 13, wherein the second end of the operating member defines splines and the first hole of the connector plate comprises corresponding splines,
further comprising selectively engaging the operating member and the connector plate at a chosen rotational position about a central axis of the first hole.

15. The method of claim 14, wherein the end of the shift knob adapter defines splines and the second hole of the connector plate comprises corresponding splines,
further comprising selectively engaging the shift knob adapter and the connector plate at a chosen rotational position about a central axis of the second hole.

16. The method of claim 13, wherein the end of the shift knob adapter defines splines and the second hole of the connector plate comprises corresponding splines,
further comprising selectively engaging the shift knob adapter and the connector plate at a chosen rotational position about a central axis of the second hole.

17. The method of claim 12, further comprising disposing a plurality of bushings within the cavity of the housing and at least partially surrounding the intermediate portion of the operating member,
wherein the bushings are spaced apart from each other at a distance corresponding to a width of the slots so as to allow the pin member to move therebetween.

18. The method of claim 11, wherein the housing is comprised of a base plate and a main portion,
wherein the main portion of the housing defines a shape that corresponds to a shape of the intermediate portion of the operating member.

19. The method of claim 11, wherein the operating member defines a first axis extending between the first end and the second end of the operating member,
wherein the longitudinal axis of the pin member is substantially perpendicular to the first axis.

20. The method of claim 19, wherein the plurality of bias members comprises two pairs of bias members,
wherein each pair of bias members is disposed proximate an end of the pin member, with each bias member of a respective pair of bias members arranged coaxially with respect to the other bias member of the respective pair and configured to act in an opposing direction with respect to the other bias member of the respective pair.
